(19) United States
(12) Patent Application Publication
(10) Pub. No.: US 2023/0070772 A1
(43) Pub. Date: Mar. 9, 2023

(54) ACTIVE THREAT TRACKING AND RESPONSE

(71) Applicant: Alarm.com Incorporated, Tysons, VA (US)

(72) Inventors: Jasper Bingham, Washington, DC (US); Alexander Kappler, Arlington, VA (US); Jed Menard, Littleton, CO (US); Allen Chien, Arlington, VA (US); John Murdock, Arlington, VA (US); Krishna Chaitanya Tummalapalli, Falls Church, VA (US); Wen-Ting Zhu, Fairfax, VA (US); Travis Martin Smith, Arlington, VA (US)

(21) Appl. No.: 17/940,160

(22) Filed: Sep. 8, 2022

Related U.S. Application Data
(60) Provisional application No. 63/241,635, filed on Sep. 8, 2021.

(51) Int. Cl. G07C 9/00

(52) U.S. Cl. CPC G07C 9/00174

(57) ABSTRACT

Methods, systems, and apparatus, including computer programs encoded on computer storage media, for active threat tracking and response. One of the methods includes determining, using sensor data generated by one or more sensors located at one or more properties, that an active threat is in progress at the one or more properties; accessing a virtual model i) of the one or more properties ii) that includes a position of each of the one or more sensors; determining, using the sensor data and the virtual model and for each of two or more areas of the one or more properties, a threat level of the active threat at the respective area; and performing, using the threat level of the active threat at each of the two or more areas of the one or more properties, one or more monitoring system actions.

### CROSS-REFERENCE TO RELATED APPLICATION

This application claims the benefit of U.S. Provisional Application No. 63/241,635, filed on Sep. 8, 2021, the contents of which are incorporated by reference herein.

### TECHNICAL FIELD

This disclosure application relates generally to monitoring systems.

### BACKGROUND

Many buildings are equipped with property monitoring systems that include sensors and connected system components. Property monitoring systems can receive and analyze data from sensors that are located at a building or at multiple buildings.

### SUMMARY

Systems and methods for active threat tracking and response are disclosed. When an active threat such as an active shooter or a fire exists at a building or campus of buildings, it is desirable to quickly locate, track, and respond to the threat. A campus monitoring system can use the disclosed techniques to detect a threat, classify the threat, monitor threat severity and movement, and communicate up-to-date threat status information to users.

The disclosed techniques can be used to detect, monitor, and track active threats such as active shooting incidents, theft, burglary, hostage situations, bomb threats, fire, physical altercations, stampedes, unauthorized access, espionage, property damage, presence of fugitives, etc. Aggregated sensor data generated by sensors located throughout a campus can be used to detect these and other threats. The sensor data can be mapped to a virtual model of a building or campus where the threat is occurring.

Based on the mapped sensor data, the monitoring system can evaluate a threat level at each of multiple different areas of the campus. The evaluated threat level can be communicated to owners, managers, occupants, and emergency responders in a visual format. The visualized threat level information can assist users in escaping from the threat and responding to the threat. The monitoring service can manipulate automated devices located throughout the campus in order to respond to the threat and mitigate the threat. The monitoring system can perform bulk actions, e.g., actions throughout an entire building or campus, or can perform individual actions that are tailored to the specific type of threat and location of the threat.

In general, one innovative aspect of the subject matter described in this specification can be embodied in methods that include the actions of determining, using sensor data generated by one or more sensors located at one or more properties, that an active threat is in progress at the one or more properties; accessing a virtual model i) of the one or more properties ii) that includes a position of each of the one or more sensors; determining, using the sensor data and the virtual model and for each of two or more areas of the one or more properties, a threat level of the active threat at the respective area; and performing, using the threat level of the active threat at each of the two or more areas of the one or more properties, one or more monitoring system actions.

In some implementations, the method includes performing the one or more monitoring system actions including sending, to a device at one of the one or more properties, instructions to cause the device to perform a monitoring system action.

In some implementations, the method includes performing the one or more monitoring system actions including sending, to a device at one of the one or more properties, instructions to cause the device to control access to an access point at one of the one or more properties to contain the active threat.

In some implementations, the method includes sending the instructions including sending, to the device, the instructions to cause the device to open the access point.

In some implementations, the method includes sending the instructions including sending, to the device, the instructions to cause the device to close the access point.

In some implementations, the method includes sending the instructions including sending, to the device, the instructions to cause the device to unlock the access point.

In some implementations, the method includes sending the instructions including sending, to the device, the instructions to cause the device to lock the access point.

In some implementations, the method includes: determining, using the sensor data by one or more sensors located at one or more properties, an estimated track of a threat through a property, including sending the instructions to cause the device to perform the one or more monitoring system actions uses the estimated track of the active threat through the property.

In some implementations, the method includes: determining an approximate location of a bystander user device, including sending the instructions to cause the device to perform the one or more monitoring system actions uses the estimated track of a threat through the property and the approximate location of the bystander user device.

In some implementations, the method of includes: determining the threat level including: determining a first threat level for a first area in the two or more areas; and determining a second different threat level for a second different area in the two or more areas; performing the one or more monitoring system actions including: performing, using the first threat level, a first action for the first area; and performing, using the second different threat level, a second different action for the second different area.

In some implementations, the method includes performing the one or more monitoring system actions including sending, to a device, instructions to cause the device to present the threat level of the active threat at each of the two or more areas of the one or more properties.

In some implementations, the method includes performing the one or more monitoring system actions including sending, to a device, instructions to cause the device to present a visualization of the threat level of the active threat at each of the two or more areas of the one or more properties. In some implementations, the method includes: determining a threat level including determining a threat type; and performing the one or more monitoring system actions including performing actions using the threat type.

Other implementations of this aspect include corresponding computer systems, apparatus, computer program products, and computer programs recorded on one or more computer storage devices, each configured to perform the actions of the methods. A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

The foregoing and other implementations can each optionally include one or more of the following features, alone or in combination.

The subject matter described in this specification can be implemented in various implementations and may result in one or more of the following advantages. Information from an emergency situation can provide responders valuable knowledge for planning and response. A map of relevant information presented to a user can provide contextual value to an emergency situation. The ability to control parts of the environment in response to sensed emergencies can provide a means of safety and flexibility to those operating in the environment.

The details of one or more implementations of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a diagram illustrating an example multi-building property monitoring system responding to an active threat.

FIG. 2 is a diagram illustrating an example visualization of a threat assessment for an emergency responder to an active threat.

FIG. 3 is a flow diagram illustrating an example process for active threat tracking and response based on multi-building property monitoring.

FIG. 4 is a diagram illustrating an example of a property monitoring system.

Like reference numbers and designations in the various drawings indicate like elements.

### DETAILED DESCRIPTION

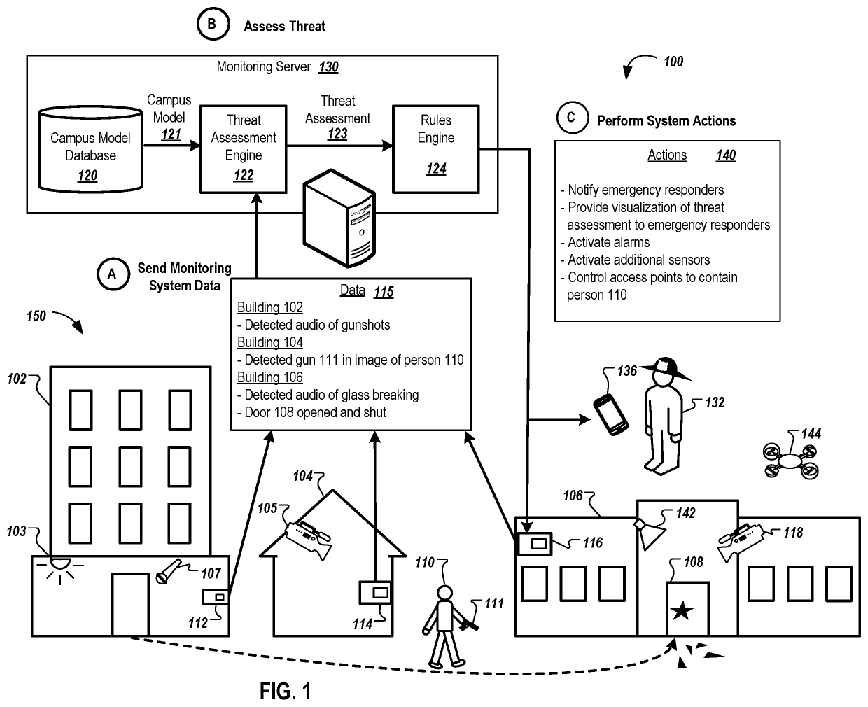

FIG. 1 is a diagram illustrating an example multi-building property monitoring system 100 for responding to an active threat. For example, the multi-building property may be a campus 150. The campus 150 includes buildings 102, 104, and 106. The campus 150 can be, for example, a school campus, an office campus, a residential campus, a multiple dwelling unit, an apartment complex, etc. The campus 150 includes the multiple buildings 102, 104, 106 and outdoor spaces between the buildings. The campus 150 can be owned or managed by a person or by an organization such as an educational or corporate organization.

The monitoring system 100 can perform threat detection and tracking at the campus 150 using sensors throughout the campus 150. The sensors can include, for example, microphone 107 at the campus 150, camera 105 at the building 104, and camera 118 at the building 106. Other sensors can include fire sensors, smoke sensors, carbon monoxide sensors, motion sensors, lock sensors access control sensors, contact sensors, and other types of sensors.

Threat tracking can include using the sensors to monitor the threats or anomalies that are detected at the campus 150. Based on the threats or anomalies detected and tracked by the sensors at the campus 150, the monitoring system 100 can perform one or more actions. The monitoring system 100 can perform actions to mitigate the threat, to aid emergency responders in responding to the threat, to assist people in evading the threat, or any combination of these.

The buildings 102, 104, 106 of the campus 150 are each opted in to monitoring and tracking by the monitoring system 100. For example, the owners or managers of the buildings 102, 104, 106 can register each of the buildings 102, 104, 106 with a monitoring service. In some examples, the campus 150 can include a neighborhood of buildings that each may have different residents and owners. Residents and homeowners of the neighborhood can each choose to opt in to or out of monitoring their buildings by the monitoring service. The monitoring service can detect threats on the campus 150, track the threats, and take actions to mitigate the threats.

The monitoring system 100 can include at least one local network. The network can be any communication infrastructure that supports the electronic exchange of data between a control unit 112 and other components of the monitoring system. For example, the network may include a local area network (LAN). The network may be any one or combination of wireless or wired networks and may include any one or more of Ethernet, Bluetooth, Bluetooth LE, Z-wave, Zigbee, or Wi-Fi technologies.

In some examples, the campus 150 includes a network, and sensors throughout the campus 150 communicate with a control unit or multiple control units over the network. In some examples, each property of the campus includes a network, and sensors of the property communicate with a control unit over the network. For example, the building 102 can include a first network, building 104 can include a second network, and building 106 can include a third network. Sensors of the building 102, e.g., the microphone 107, can communicate with a control unit 112 of the building 102 over the first network. Similarly, the camera 105 can communicate with the control unit 114 of the building 104 over the second network, and the camera 118 can communicate with control unit 116 over the third network.

The sensors can transmit the sensor data to the control units 112, 114, 116 via the network. Example sensor data can include indoor and outdoor motion sensor data, images and video analysis data from security cameras, and door and window position and lock data. The control units 112, 114, 116 can collect and assess the data from the sensors to monitor the conditions of the campus 150.

The control units 112, 114, 116 can each be, for example, a computer system or other electronic device configured to communicate with the sensors. The control units 112, 114, 116 can also perform various management tasks and functions for the monitoring system. In some implementations, a resident, a visitor, or another user can communicate with the control units 112, 114, 116 (e.g., input data, view settings, or adjust parameters) through a physical connection, such as a touch screen or keypad, through a voice interface, or over a network connection.

In some examples, the control units 112, 114, 116 can analyze some or all of the sensor data. For example, the control units 112, 114, 116 can analyze motion sensor data, video images, and microphone data to determine the occupancy of the buildings of the campus 150. The control units 112, 114, 116 can also analyze sensor data to determine locations of the residents and/or other occupants within the campus 150.

The monitoring system 100 includes one or more sensors located at the campus 150 that collect sensor data related to the campus 150. The monitoring system 100 has the ability to control various sensors and other devices on the campus 150 through automation controls. The sensors of the monitoring system collect various sensor data from the campus 150. Example sensors can include cameras, motion sensors, microphones, thermometers, smoke detectors, and water meters. The sensors can also include position sensors and lock sensors for doors and windows at the campus 150.

An example sensor at the campus 150 is an outdoor security camera 105. The outdoor security camera 105 may be used to monitor people, vehicle, and animals at the campus 150. In some implementations, the security camera 105 may perform video analysis on the images captured by the security camera 105. In some implementations, the security camera 105 may transmit images to a monitoring server 130 and the monitoring server 130 may perform video analysis on the images. The security camera 105 and/or the monitoring server 130 may perform video analysis on the images to detect and identify objects and/or perform facial recognition within the field of view of the security camera 105. For example, the security camera 105 may detect and identify animals, vehicles, and people.

The cameras 105, 118 can include any type of camera. The cameras can capture images of the interior and exterior areas of the campus 150. The images can be generated from any appropriate type of light. For example, the images can be generated from any combination of visible light, IR light, or UV light. The images can also be generated from RADAR, LIDAR, and/or microwave imaging.

The monitoring system 100 can include one or more drones, e.g., drone 144. The drone 144 can be stored at a location of the campus 150. The drone 144 can include one or more sensors such as a camera. The drone 144 can be deployed by the monitoring system in response to detecting a threat on the campus 150. The drone 144 can be, for example, an autonomous drone and/or remote controlled drone. The drone 144 can be an aerial drone or a terrestrial drone. The drone can be capable of mobility, e.g., by flying, rolling, swimming, etc.

The monitoring server 130 includes a campus model database 120. The database 120 stores a virtual campus model 121 of the campus 150. In some examples, the campus model database 120 can store virtual models of multiple campuses.

The campus model 121 can include a two-dimensional (2D) map, a three-dimensional (3D) map, or both, of the campus 150. For example, the campus model 121 can include a map of each of the buildings 102, 104, 106 of the campus 150. In some examples, the campus model 121 can include a floor plan of each floor of the buildings 102, 104, 106. In some examples, the campus model 121 can include a map of outdoor space of the campus 150.

The campus model 121 can include a map of sensors of each of the buildings of the campus 150. For example, the campus model 121 can include a position of the camera 105 indicated on the map of the building 104. The campus model 121 can include data indicating a sensor area of each sensor. The sensor area of a sensor can include, for example, a maximum range of the sensor, a field of view of the sensor, an area or volume of the property that is within detection range of the sensor, etc. For example, the campus model 121 can include data indicating a 2D or 3D field of view of the camera 105. The field of view of the camera 105 can be overlaid on the map of the campus 150.

The campus model 121 can include of map of devices at each of the buildings of the campus 150. For example, the campus model 121 can include a position of doors, windows, locks, alarms, lights, speakers, etc. The campus model 121 can include, e.g., a location of the alarm 103 at the building 102 and a location of the speaker 142 at the building 106. The devices can include automated devices, e.g., devices that can be operated by the monitoring server 130 using automated controls.

The campus model 121 can be generated at or after a time when the campus 150 is registered with the monitoring service. For example, when a manager of the campus 150 registers the campus 150 with the monitoring service, the manager or another user can provide information to the monitoring server 130 indicating a layout of the campus, locations of sensors, types of sensors, etc. In some examples, the manager can provide the information to the monitoring server 130 through a user interface of a computing system. In some examples, the manager can provide the information to the monitoring service by recording or streaming a video walkthrough of the campus 150 to the monitoring server 130.

In some examples, the monitoring server 130 can update the campus model 121 over time. For example, the monitoring server 130 can update the campus model 121 based on sensor data collected at the campus 150 over time. In some examples, the monitoring server 130 can update the campus model 121 based on user input. As an example, a user may reposition the camera 118 at the building 106. The monitoring server 130 can update the campus model 121 based on user input indicating the updated position of the camera 118. In some cases, the monitoring server 130 can detect movement of the camera 118, and can prompt the user to input an updated position of the camera 118. In some cases, the monitoring server 130 can detect movement of the camera 118, and can automatically update the position of the camera 118 in the campus model 121 based on camera images collected from the camera 118.

FIG. 1 illustrates a flow of data, shown as stages (A) to (C), which can represent steps in an example process. Stages (A) to (C) may occur in the illustrated sequence, or in a sequence that is different from the illustrated sequence. For example, some of the stages may occur concurrently.

In the example scenario illustrated in FIG. 1, a person 110 fires gunshots in the building 102 and carries a firearm 111 through the campus 150 past the building 104. The person 110 breaks glass of the door 108 of the building 106 and enters the building 106.

In stage (A) of FIG. 1, control units 112, 114, 116 send monitoring system data 115 to a monitoring server 130. The data 115 includes audio data from the microphone 107 at the building 102, indicating detected audio of gunshots. In some examples, gunshots can be detected by a dedicated gunshot detection system. The gunshot detection system can include acoustic and/or infrared sensors that are configured to detect gunfire. In some examples, the data 115 includes an indication that the gunshot detection system has detected gunfire. In some examples, the data 115 can include a number of gunshots that have been detected by the gunshot detection system. In some examples, the data 115 can include a confidence value that the gunshot detection system has detected gunfire.

The data 115 also includes image data from the camera 105 at the building 104, indicating images of a person 110 walking past the building 104. The data 115 also includes results of image analysis of the images captured by the camera 105. The results of the image analysis indicate detection of a firearm 111 in the images of the person 110. The data 115 also includes audio data from a glass break sensor indicating breaking glass at the building 106. The data 115 also include data indicating that the door 108 opens and shuts. The data indicating that the door 108 opens and shuts can include a door position sensor and/or images captured by the camera 118 showing the door 108 opening and shutting.

In some examples, cameras at the campus 150 can analyze captured images, e.g., using video analytics. For example, the camera 105, the camera 118, or both, can perform video analysis on the images to classify objects within the images. The cameras may identify and classify the person 110 within the images. The cameras can also perform object tracking of the person 110 as the person 110 travels across the campus 150.

In some examples, cameras at the campus 150 can transmit image data to the monitoring server 130, and the monitoring server 130 can perform video analysis on the image data. For example, the camera 105 can capture an image of the person 110 with the firearm 111 and transmit the image to the monitoring server 130. The monitoring server 130 can perform video analysis in order to classify the object in the image as a person, to determine a direction of motion of the person, to perform facial recognition of the person 110, to classify the object carried by the person 110 as a firearm 111, etc.

The data 115 can include timestamps associated with the data. The timestamps can indicate a time that the data was generated by the sensors or a time that the data was sent to the control unit. For example, the microphone data can be associated with a timestamp of 2:00 pm. The image data including the detected firearm 111 can be associated with a timestamp of 2:24 pm. The audio data from the glass break sensor can be associated with a timestamp of 2:27 pm. The data indicating that the door 108 opens and shuts can be associated with a timestamp of 2:28 pm.

The data 115 can include confidence values associated with the data. For example, the microphone data can be associated with a confidence value of seventy percent, indicating that there is a seventy percent chance that the audio data represents gunshots. The image data can be associated with a confidence value of sixty percent confidence that the object in the image is a gun. The data indicating that the door 108 opens and shuts can be associated with a confidence value of ninety percent confidence that the door 108 opened and shut. The confidence values can be determined, for example, by the sensor that generated the data or by the control unit.

The monitoring server 130 may be, for example, one or more computer systems, server systems, or other computing devices that are located remotely from the campus 150 and that are configured to process information related to the monitoring system at the campus 150. In some implementations, the monitoring server 130 is a cloud computing platform.

The control units 112, 114, 116 send the data 115 to the monitoring server 130. The data 115 includes data collected from sensors at the campus 150. In some examples, a central control unit can send the data 115 to the monitoring server 130. For example, the central control unit may be the control unit 112. The control units 114, 116 can transmit data to the control unit 112, and the control unit 112 can transmit the data to the monitoring server 130. In some examples, the sensors of the buildings 102, 104, 106 can transmit data to the central control unit, e.g., control unit 112, and the central control unit can transmit the data to the monitoring server 130. In some examples, the sensors of the buildings 102, 104, 106 can transmit data to the monitoring server 130.

The control unit or control units can send the data 115 to the monitoring server 130 over a long-range data link. The long-range data link can include any combination of wired and wireless data networks. For example, the control units 112, 114, 116 can exchange information with the monitoring server 130 through a wide-area-network (WAN), a broadband interne connection, a cellular telephony network, a wireless data network, a cable connection, a digital subscriber line (DSL), a satellite connection, or other electronic means for data transmission. In some implementations, the long-range data link between the control units 112, 114, 116 and the monitoring server 130 is a secure data link (e.g., a virtual private network) such that the data exchanged between the control units 112, 114, 116 and the monitoring server 130 is encoded to protect against interception by an adverse third party.

In stage (B) of FIG. 1, the monitoring server 130 assesses threats at the campus 150 based on the data 115. The monitoring server 130 can analyze the data 115 to determine conditions at the campus 150.

The monitoring server 130 includes a threat assessment engine 122 and a rules engine 124. The threat assessment engine 122 uses the campus model 121 and the data 115 to assess a threat level of different areas of the campus 150. The threat assessment engine 122 outputs a threat assessment to the rules engine 124. The rules engine 124 determines one or more actions 140 to perform based on the threat assessment 123.

The threat assessment engine 122 determines the threat assessment based on the data 115. For example, the threat assessment engine 122 can receive the data 115 generated from sensors at the campus 150. In response to receiving the data 115 from the sensors at the campus 150, the threat assessment engine 122 can retrieve the campus model 121 of the campus 150 from the campus model database 120. The threat assessment engine 122 can map the data 115 to the campus model 121. For example, the threat assessment engine 122 can map the audio data of detected gunshots to the building 102. In some examples, the threat assessment engine 122 can map the audio data of detected gunshots to a particular area of the building 102 based on the location of the microphone 107. For example, the threat assessment engine 122 can map the audio data to a particular room, floor, hallway, stairway, etc. of the building 102 based on the detection range of the microphone 107.

In some examples, the monitoring server 130 can determine confidence values of the data 115 instead of receiving confidence values determined by the sensors or by the control unit. For example, the monitoring server 130 may assign the microphone data with a confidence value of sixty percent, indicating that there is a sixty percent chance that the audio data represents gunshots. In some cases, the confidence value for the data 115 can be based at least in part on coincidence logic. For example, the monitoring server 130 may assign audio data indicating gunshot noises alone a confidence value of fifty percent. The monitoring server 130 may assign audio data representing gunshot noises a higher confidence value based on coincidence with additional data. For example, for audio data representing gunshot noises in coincidence with audio data representing screaming, e.g., captured within a time and distance proximity to each other, the monitoring server 130 may assign a higher confidence value of eighty percent that the audio data represents gunshots.

Based on the data 115, the threat assessment engine 122 can determine that a threat exists at the campus 150 and can classify the threat. For example, based on the gunshots detected in building 102, the threat assessment engine 122 can determine that an active shooter threat exists at the campus 150. In some examples, the threat assessment engine 122 can detect and classify threats using programmed rules. In some examples, the threat assessment engine 122 can detect and classify threats using machine learning algorithms. The machine learning algorithms can be trained using supervised or unsupervised methods. The threat assessment engine 122 can update machine learning parameters over time based on sensor data and threat events detected at the campus 150 and other campuses.

In some examples, the threat assessment engine 122 can evaluate a likelihood or confidence that a threat exists at the campus 150. The threat assessment engine 122 can update the confidence of the threat based on additional sensor data. For example, based on the audio data indicating the detected gunshots, the threat assessment engine 122 may determine a confidence of sixty percent that an active shooter threat exists at the campus 150. Based on the image of the person 110 with the firearm 111, the threat assessment engine may determine an updated confidence of eighty percent that an active shooter threat exists at the campus 150.

In some examples, the threat assessment engine 122 can determine the confidence that a threat exists at the campus 150 based on confidence levels of the sensors data. For example, audio data indicating detected gunshots can have a confidence level of sixty percent for representing an active shooting threat. An image of a firearm in a captured image can have a confidence level of seventy percent for representing an active shooting threat. The threat assessment engine 122 can determine a confidence that the threat exists at the campus 150 based on a combination of confidence levels of different sensor data. The combination can include, for example, a weighted sum or a weighted average of confidence levels.

The threat assessment engine 122 can detect a threat such as an active shooter threat based on any sensor data. The sensor data can include, for example, motion sensor data indicating people escaping from the building 102, audio data indicating yelling or screams, doors opening and shutting multiple times, vibration indicating people running, etc.

In some examples, the threat assessment engine 122 can classify the type of threat. For example, based on the detected gunshots, the threat assessment engine 122 can determine that a threat exists and can classify the threat as an active shooter threat or as an isolated shooting incident threat. The threat assessment engine 122 may determine a confidence value of eighty percent that the threat is an active shooter threat and of sixty percent that the threat is an isolated shooting incident.

In some examples, the threat assessment engine 122 can determine a current threat level at different areas of the campus 150. The threat level can be represented by a percentage, a scale, a descriptor, a color, etc. For example, based on the audio data indicating the detected gunshots at the building 102, the threat assessment engine 122 may determine that a high threat level exists at the building 102, and that a lower threat level exists at the building 104, based on a proximity of the building 104 to the building 102. The threat assessment engine 122 may determine that an even lower threat level exists at the building 106, based on a proximity of the building 106 to the building 102.

The threat assessment engine 122 can assign a representation to a threat level of different areas of the campus 150. A higher threat level can be represented, e.g., by a high percentage such as ninety percent, by a large scale value such as nine out of ten, by a descriptor such as “high” or “very dangerous,” by a color such as red, etc. A medium threat level can be represented, e.g., by a medium percentage such as fifty percent, by a medium scale value such as five out of ten, by a descriptor such as “medium” or “possibly dangerous,” by a color such as yellow, etc. A low threat level can be represented, e.g., by a low percentage such as twenty percent, by a small scale value such as two out of ten, by a descriptor such as “low” or “not dangerous,” by a color such as green, etc.

The threat assessment engine 122 can detect and track multiple threats at the campus 150. In some examples, the threat assessment engine 122 can detect and track multiple threats at multiple different campuses. Upon detecting a threat, the threat assessment engine 122 can assign received data 115 to the threat. For example, the threat assessment engine 122 can determine that an active shooter threat likely exists at the building 102 based on the detected gunshots. At or near the same time, the threat assessment engine 122 can receive a second set of data from a second building on the campus 150 can determine based on the second set of data that a burglary threat likely exists at the second building.

When the monitoring server 130 receives the image data from camera 105 at the building 104, the threat assessment engine 122 can assign the image data to one of the already detected threats on the campus 150, or can determine that the image data of the person 110 corresponds to a new threat on the campus 150.

In the example of FIG. 1, the threat assessment engine 122 can assign the image data to the active shooter threat on the campus 150, e.g., based on a proximity of the building 104 to the building 102. For example, the threat assessment engine 122 can determine that the building 104 is closer in proximity to the building 102 than to the second building where the burglary threat was detected.

The threat assessment engine 122 can assign the image data to the active shooter threat on the campus 150, e.g., based on the timestamp associated with the audio data of the detected gunshots at the building 102 and the timestamp associated with the image data captured by the camera 105 at the building 104. For example, the threat assessment engine 122 can determine that the timestamp associated with the image data is closer in time to the timestamp associated with the detected gunshots than with the sensor data indicating the burglary threat.

In some examples, the threat assessment engine 122 can assign data to the active shooter threat on the campus 150, e.g., based on tracking movement of the person 110. For example, the threat assessment engine 122 can determine, based on the image data captured by the camera 105, that the person 110 is walking towards the building 106. The threat assessment engine 122 can determine, based on second set of data representing the burglary threat, that the suspected burglar is walking in a direction away from the building 106 and/or is located far from the building 106. Thus, the threat assessment engine 122 can assign the audio data indicating glass breaking at the building 106 to the active shooter threat instead of to the burglary threat.

In some examples, the threat assessment engine 122 can assign data to a detected threat based on proximity or timestamp rules. For example, sensor data captured within a threshold proximity to a detected threat can be assigned to the detected threat. The threshold proximity can be, e.g., 0.1 miles, one hundred feet, two hundred feet, etc. The threshold proximity can also include the sensor data being captured on the same floor of a building where the threat is detected, in a same wing of a building where the threat is detected, etc. For example, the building 104 is within 0.1 miles of the building 102. The threat assessment engine 122 can therefore associate the image data captured by the camera 105 with the detected active shooter threat based on the building 104 being within a threshold distance of 0.1 miles of the building 102 where the active shooter threat was detected.

The threat assessment engine 122 outputs the threat assessment 123 to the rules engine 124. The threat assessment 123 can include a classification of a detected threat, e.g., a classification of the detected threat as an active shooter threat. The threat assessment 123 can also include a confidence level of the detected threat. The threat assessment 123 can also include a threat level of different areas of the campus 150.

The rules engine 124 determines monitoring system actions based on the threat assessment 123. The rules engine 124 can determine monitoring system actions based on pre-programmed settings and rules. Rules and settings can be customizable and may be programmed, e.g., by an owner, resident, an installer, an operator, or another user of the monitoring system. For example, a rule may state that the monitoring server 130 sends a notification to emergency responders when a confidence of an active shooter event exceeds sixty percent. In some examples, a rule may state that the monitoring server 130 shuts and locks doors at the campus 150 when an active shooter is determined to be within a particular area of the campus 150 with a confidence of greater than seventy percent. In some examples, the monitoring server 130 may be programmed to request permission from a user before adjusting a device at the campus 150.

In some examples, the rules engine 124 can determine bulk actions based on the threat assessment 123. The bulk actions can include a pre-determined set of actions to be taken for a given threat. For example, a first set of bulk actions may apply to an active shooter threat anywhere on the campus 150. The first set of bulk actions may include notifying emergency responders, activating available sensors within a threshold range of the threat, and broadcasting an emergency alert to mobile devices within a particular geographic range to the threat. A second set of bulk actions may apply to a fire threat anywhere on the campus 150. The second set of bulk actions may include notifying emergency responders, activating alarms of buildings within a threshold range of the threat, and activating fire suppression systems at the location of the threat.

In some examples, the rules engine 124 can determine to change a state of the monitoring system 100 based on the threat assessment 123. For example, the threat assessment 123 may indicate an active shooter threat with a confidence of greater than sixty-five percent. Based on the threat assessment 123, the rules engine 124 can determine to change the state of the monitoring system 100 to a higher alert state. In the higher alert state, the monitoring server may collect sensor data from a greater number of sensors at the campus 150, may collect sensor data from sensors at the campus 150 at an increased frequency, etc. For example, based on entering the higher alert state based on sensor data collected at building 102, the monitoring server 130 can obtain sensor data from a greater number of sensors, including sensors at buildings 104, 106, and/or other buildings at the campus 150.

The rules engine 124 can determine monitoring system actions based on the confidence of the detected threat. The actions can include sending notifications to users. For example, at a threat confidence of fifty percent, the rules engine 124 can determine to send a notification to an owner or manager of the campus 150. At a threat level of seventy percent, the rules engine 124 can determine to send a notification to emergency responders. At a threat level of seventy-five percent, the rules engine 124 can determine to send a notification to occupants of the campus and/or to people within a proximity of the campus 150.

In an example, the threat assessment 123 can include a confidence of fifty percent for an active shooter threat. Based on the confidence of fifty percent, the rules engine 124 can determine an action of notifying the campus manager, e.g., by transmitting a notification to a computing device of the campus manager. The rules engine 124 may receive an updated threat assessment 123 indicating a confidence of seventy percent for an active shooter threat. Based on the confidence of seventy percent, the rules engine 124 can determine an action of notifying emergency responders, e.g., by placing a telephone call to an emergency response center. The rules engine 124 may receive an updated threat assessment 123 indicating a confidence of seventy-five percent for an active shooter threat. Based on the confidence of seventy-five percent, the rules engine 124 can determine an action of notifying occupants of the campus 150. For example, the monitoring server 130 can notify occupants by triggering one or more alarms at the campus 150, by broadcasting an audible notification at one or more buildings of the campus 150, by broadcasting an emergency alert within a designated radius through programs such as a Wireless Emergency Alert program.

The rules engine 124 can determine monitoring system actions based on tracking the person 110. For example, the threat assessment 123 can include an estimated path that the person 110 has taken through the campus 150, an estimated current location of the person 110, a predicted path of the person 110, or any combination of these. The threat assessment 123 can include an estimated current location of the person 110 as being in a first room of the building 106. Based on the estimated current location of the person 110 as being in the first room of the building 106, the rules engine 124 can determine monitoring system actions 130 that prevent the person 110 from exiting the first room, or from exiting the building 106. The monitoring system actions 130 can include, for example, shutting one or more interior or exterior doors, locking one or more interior or exterior doors, shutting one or more windows, locking one or more windows, deactivating one or more elevators, etc. Thus, the monitoring server 130 can perform actions in order to isolate or contain the threat.

The rules engine 124 can determine monitoring system actions based on tracking bystanders and victims at the campus 150. A bystander can be, for example, a person who is not considered a threat but who is located near the threat. Bystanders may be able to move about the campus in order to evade the threat. A victim can be, for example, a person who has been harmed by the threat. Victims might be hindered in their movement about the campus, e.g. due to injuries or due to a captive or hostage situation.

The threat assessment engine 122 can determine bystander and victim locations based on sensor data, and the threat assessment 123 can include the estimated locations of victims, and locations of bystanders who may be sheltering in the buildings 102, 104, 106. Based on the estimated locations of the victims, the rules engine 124 can determine monitoring system actions 140 that assist emergency responders in locating the victims. For example, the monitoring system actions 140 can include activating lighting to illuminate a path to the victims, broadcasting audible directions through a speaker, etc. Based on the estimated locations of the bystanders, the rules engine 124 can determine monitoring system actions 130 that prevent the person 110 from locating and/or accessing areas of the buildings where bystanders are located. For example, the monitoring system actions 140 can include locking doors, locking windows, shutting shades or shutters, etc.

In some examples, the rules engine 124 can determine monitoring system actions 130 that assist people in escaping from the threat. For example, the monitoring system actions 130 may contain the threat in the first room of the building 106 by locking doors and windows of the first room of the building 106. The rules engine 124 can then determine to unlock locked doors and automatically hold open other doors and/or windows of the building 106 in order to provide an escape path for people in the building 106.

The rules engine 124 can determine escape paths based on the threat assessment 123 mapped to the campus model 121. For example, the threat assessment 123 may indicate that people are located in a second room at the building 106, and that a hallway of the building 106 leads to an exit without passing the current location of the person 110. The rules engine 124 can determine actions 140 that permit the people to escape down the hallway. In some examples, the rules engine 124 can determine actions 140 that guide the people to follow the escape path, e.g., by broadcasting audio guidance through speakers at the building 106.

In some examples, the rules engine 124 can determine actions 140 that guide people to follow the escape path by illuminating lights along the escape path. For example, the rules engine 124 can illuminate overhead lighting along the escape path, and distinguish overhead lighting in unsafe areas. In some examples, the rules engine 124 can determine actions that use color-coded lights to guide people to follow the escape path. For example, the rules engine 124 can determine to illuminate safe passages in green light, and to illuminate dangerous passages in red light.

Using the campus model 121, the rules engine 124 can identify isolable areas of the campus. Isolable areas of the campus are areas that are capable of being isolated, e.g., using doors, windows, and/or locks. Isolating an area can include securing all accesses to the area such that a person within the area cannot get out of the isolated area. Isolable areas of the campus can include, for example, a building, a wing of a building, a floor of a building, an elevator, a hallway, a room, a tunnel, an overpass, or another area of the campus.

The rules engine 124 can monitor each isolable area to determine whether the threat is located within an isolable area. In some examples, the rules engine 124 can isolate an isolable area based on determining that the threat is located within the isolable area. In some examples, the rules engine 124 can isolate the isolable area based on determining that the threat is located within the isolable area and that no bystanders are located within the isolable area. Once the isolable area is isolated, the rules engine 124 can determine actions to impede the threat, e.g., by turning off all lights in the isolable area.

In some examples, the rules engine 124 may determine that the threat is located within an isolable area and that bystanders are also located within the isolable area. The rules engine 124 can continue to monitor the isolable area using sensor data to determine when all bystanders have departed from the isolable area. Based on determining that all bystanders have departed from the isolable area, and that the threat is still located within the isolable area, the rules engine 124 can isolate the isolable area by securing all accesses to the isolable area to contain the threat.

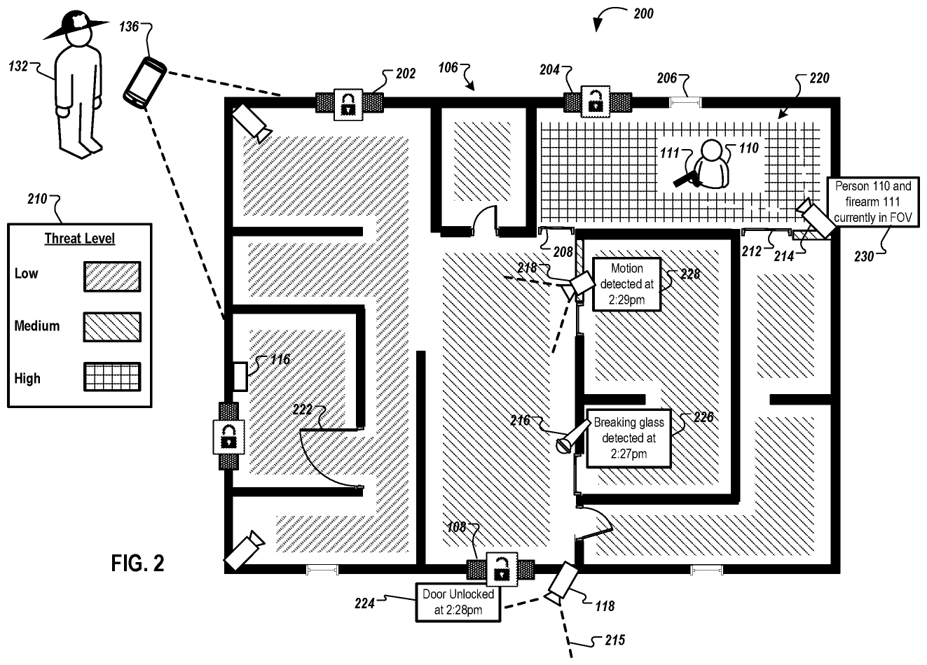

In stage (C) of FIG. 1, the monitoring server 130 performs system actions 140 as determined by the rules engine 124. For example, based on the determination that an active shooter threat exists at the campus 150, and that the person 110 has a firearm 111 and has a current location within the building 106, the monitoring server 130 can perform an action 140 of sending a notification or an alert to an emergency responder 132. Emergency responders such as the emergency responder 132 may be, for example, police personnel, firefighters, security guards, emergency medical personnel, etc. The emergency responder 132 can receive the alert on a device such as a mobile device 136. The monitoring server 130 can also send alerts and notifications to owners and occupants of the campus 150 as determined by the rules and settings. The actions 140 can include providing a visualization of the threat assessment 123 to the emergency responders. An example visualization of a threat assessment 123 is described with reference to FIG. 2.

The actions 140 can include activating additional sensors at the campus 150. The additional sensors may be installed at the campus 150 or may be mounted to automated or remotely operated vehicles such as aerial drone 144. The monitoring server 130 transmit an instruction to the drone 144 that causes the drone to deploy to the estimated location of the threat, e.g., building 106. Sensors of the drone 144 can obtain additional sensor data and provide the additional sensor data to the monitoring server 130. Based on the additional sensor data, the threat assessment engine 122 can update the threat assessment 123.

In some examples, autonomous or remotely controlled vehicles such as the drone 144 can perform additional actions as determined by the rules engine 124. For example, the monitoring server 130 can deploy the drone 144 to guide people to safety. The drone 144 can deploy to locations where bystanders are located, and can provide a signal to the bystanders indicating to follow the drone 144. The signal can include, e.g., an audio or visual signal. The drone 144 can then travel along an escape path determined by the monitoring server 130 using the threat assessment 123 and the campus model 121.

In some examples, the monitoring server 130 can deploy the drone 144 to the location of the threat in order to mitigate the threat. For example, the drone 144 can include lethal and/or non-lethal weapons. The lethal and/or non-lethal weapons can be used to harm, mark, or distract the person 110. The lethal and/or non-lethal weapons can include, e.g., tasers, pepper spray, firearms, tear gas, long-range acoustic devices (LRAD), permanent ink, etc. The monitoring server 130 can deploy the drone 144 to the estimated location of the person 110. When the drone 144 intercepts the person 110, the drone 144 can attack the person 110 using the weapons.

In some examples, the monitoring server 130 can perform system actions 140 that include adjusting or configuring one or more devices at the campus 150. The monitoring server 130 may send a command to adjust a device at the campus 150 via the control unit 112. For example, the monitoring server 130 can send a command to the control unit 112 to shut and lock doors and to shut and lock windows at the campus 150. The control unit 112 can adjust the doors, windows, etc., via automation controls. In some examples, the monitoring server 130 can trigger an alarm at the campus 150, e.g., an audio and/or visual alarm.

In some examples, the monitoring server 130 can adjust devices at the campus 150 without any user action. In some examples, the monitoring server 130 can provide recommended actions to a user, and can perform the actions upon approval by the user. For example, the monitoring server 130 may provide recommended actions to a user such as the manager or owner of the campus, and request approval of the actions. Upon approval of the actions, the monitoring server can perform the actions 140. In some examples, the monitoring server 130 can provide recommended actions to the user with a time limit. If the user does not respond to approve or deny the actions within the time limit, the monitoring server 130 may perform the actions 140.

In some examples, some of the actions 140 require approval by a user, while other actions can be performed without user approval. In some examples, user approval may be required for lower confidence threats, while user approval might not be required for higher confidence threats. For example, for an active shooter threat with a confidence value of less than sixty-five percent, the monitoring server 130 may request approval before notifying emergency responders, in accordance with rules and settings. For an active shooter threat with a confidence value of greater than or equal to sixty-five percent, the monitoring server 130 may notify emergency responders without requesting approval from a user.

In some examples, the monitoring server 130 may perform actions 140 related to increasing security measures at campus buildings. For example, control units of buildings near the campus 150 may communicate with the same monitoring server 130. The monitoring server 130 can send commands to the buildings to adjust devices and/or equipment at the buildings. For example, the monitoring server 130 can send commands to buildings to activate external security cameras at the buildings. The security cameras can then send collected images to the monitoring server 130.

In some examples, in response to detecting the threat at the campus 150, the monitoring server 130 can send commands to campus buildings to shut and/or lock doors or arm monitoring systems at the buildings. In some examples, the monitoring server 130 can send data to monitoring systems of campus buildings indicating that the threat occurred. The monitoring systems of the campus buildings can then use automation controls to adjust and configure devices based on rules and settings of the monitoring systems.

The actions 140 can include send an alert to users that includes the location of the campus 150, the time of the threat, and the current location, route, speed of the person 110, and/or other information. The alert can also include details about the person 110 based on the data 115, e.g., security camera 105 images. For example, the alert can include the number of personnel and whether or not the personnel are armed.

The notification can include a message stating that an active shooter situation is in progress. The monitoring server 130 can send the notification to residents or occupants via, for example, a text message that the occupants can receive on a mobile device. The mobile device can be any type of data carrying computing device. For example, the mobile device can be a laptop computer, a tablet, smart watch, a video game console, or a smart car. The monitoring server 130 can also send the notification to users via, for example, a telephone call.

In some examples, the monitoring server 130 can perform system actions 140 that include adjusting access control devices at the campus 150. Access control devices can include, for example, access control readers such as badge readers, ID card readers, key fob readers, mobile credential readers, etc. Access control devices can be installed at any indoor or outdoor access point of the campus 150. For example, access control devices can be installed to permit people to enter and/or exit buildings, rooms, hallways, etc. For example, an access control device may be installed on the door 108 or near the door 108, e.g., on a wall next to the door 108. When a person scans a badge at the access control device, the access control device can verify the badge and unlock the door 108, permitting the person to enter the building 106.

Access control devices can include lighting components, audio components, or both. For example, an access control device can include lighting components such as LED lights of various colors. An access control device can also include audio components such as speakers and buzzers. The lighting components and audio components can be used to indicate permission or denial to access a space. For example, when the access control device verifies a scanned credential, the access control device can indicate the verification, e.g., by illuminating a green light. When the access control device fails to verify a scanned credential, the access control device can indicate the failed verification, e.g., by illuminating a red light and activating a buzzer.

The monitoring server 130 can transmit commands to adjust access control devices, e.g., by sending a command to activate lighting components and/or audio components of access control devices to warn of dangerous conditions. For example, a gunshot detection system may detect gunshots in a particular room of the building 102. Based on the detected gunshots in the particular room, the monitoring server 130 can transmit a command to an access control device installed on a door to the particular room. For example, the command can instruct the access control device to flash LED lights in a pattern, e.g., by alternating between red and orange LED colors to indicate dangerous conditions in the particular room. In some examples, the command can instruct the access control device to broadcast audible beeping or buzzing sounds to indicate dangerous conditions in the particular room.

In some examples, the monitoring server 130 can transmit commands to activate lighting components and/or audio components of access control devices to indicate safe areas and escape paths. For example, a gunshot detection system may detect gunshots in a particular room of the building 102. The monitoring server 130 can identify safe areas and escape paths that are clear of the particular room, and can transmit commands to access control devices in the safe areas and along the escape paths. For example, the command can instruct the access control devices to flash a green color to indicate safety.

In some examples, the monitoring server 130 can transmit commands to adjust access control devices, e.g., by sending a command to a control device to lock or unlock a door. For example, the monitoring server 130 may determine that bystanders are located in a dangerous area of the campus 150, and that access through a door to an escape path is controlled by a particular access control device. The monitoring server 130 can transmit a command to the particular access control device that causes the particular access control device to unlock the door, permitting the bystanders to access the escape path.

In some examples, the monitoring server 130 may determine that a threat, e.g., person 110, is alone in a room, and that an exit door from the room is controlled by a particular access control device. The monitoring server 130 can transmit a command to the particular access control device that causes the particular access control device to lock the exit door, trapping the person 110 in the room. The monitoring server 130 can transmit a command to the particular access control device that revokes access to the room. Therefore, when another person approaches the locked room and scans an authorized access badge, the control device will prevent the person from entering the room where the threat has been trapped.

In some examples, a gunshot detection system can be paired to one or more access control devices. For example, a gunshot detector installed in a room can be paired to access control devices that control access to the room. The gunshot detector can communicate with the access control device, e.g., through a wired or short-range wireless connection. When the gunshot detector detects gunfire in the room, the gunshot detector can transmit a signal to the access control device. The signal can cause the access control device to perform one or more actions. For example, based on receiving the signal from the gunshot detector, the access control device can signal dangerous conditions in the room by flashing lights, by broadcasting audio sounds, etc. In some examples, based on receiving the signal from the gunshot detector, the access control device can unlock in order to permit bystanders to exit from the room.

In some examples, the monitoring server 130 can perform system actions 140 that include sending notifications of the threat to residents of campus buildings or nearby properties. For example, properties that are near to the campus 150 may have monitoring systems that can communicate with the monitoring server 130. Residents of the campus buildings may opt-in to receiving alerts and notifications from the monitoring server 130 based on anomalies detected at the campus 150 and/or other buildings in the area. In some examples, the monitoring server 130 may perform system actions 140 that include adjusting or configuring devices at the campus buildings using automation controls. In some examples, the monitoring server 130 may perform system actions 140 that include requesting permission from managers of campus buildings before adjusting devices at the campus buildings in response to the detected threat. The monitoring server 130 may include preprogrammed rules and settings for each of the campus buildings.

Though described above as being performed by a particular component of monitoring system 100 (e.g., the control units 112, 114, 116 or the monitoring server 130), any of the various control, processing, and analysis operations can be performed by either the control units, the monitoring server 130, the sensors, or another computer system of the monitoring system 100. For example, the control units, the monitoring server 130, the sensors, or another computer system can analyze the images and data from the sensors to detect a threat. Similarly, the control units, the monitoring server 130, the sensors, or another computer system can control the various sensors, and/or the property automation controls, to collect data or control device operation.

FIG. 2 is a diagram illustrating an example visualization 200 of a threat assessment for an emergency responder 132. The visualization 200 can be presented on a display of a computing device, e.g., the mobile device 136 associated with the emergency responder 132. The visualization 200 can include a 2D or 3D visual representation of the campus model 121 overlaid with data from the threat assessment 123. The visualization 200 of FIG. 2 shows an example threat assessment of the building 106. The person 110 is in a room 220 of the building 106 with the firearm 111.

Though the visualization 200 of FIG. 2 shows a single floor of a single building, the visualization of the threat assessment 123 can include additional floors and additional buildings of the campus 150. For example, the emergency responder 132 can view a visualization of multiple floors of the building 106 and/or a visualization of the buildings 102, 104, and 106. In some examples, the visualization 200 can include depictions of outdoor spaces, e.g., outdoor spaces of the campus 150 between the buildings 102, 104, 106. The depictions of outdoor spaces can include a 2D or 3D terrain map, including locations of features such as hills, trees, boulders, hedges, etc.

In some examples, the emergency responder 132 can access the visualization 200 using an application of the mobile device 136. Emergency response organizations can have registered accounts with the monitoring service that permit the emergency responders to access the visualization 200. The application can perform an authentication process to allow the emergency responder 132 to view the visualization 200. In some examples, the authentication process can be performed as part of a dispatch process for the emergency responder. For example, when the emergency responder 132 is dispatched to respond to the threat, the dispatching officials can send authentication credentials to the mobile device 136 that permit the emergency responder 132 to access the visualization.

In some examples, access to the visualization is based in part on a geographic location of the mobile device 136, e.g., based on a GPS location of the mobile device 136. For example, when the emergency responder 132 approaches within a particular geographic range to the building 106, e.g., a range of a quarter mile or less from the building 106, the application of the mobile device 136 can prompt the emergency responder 132 to enter credentials to access the visualization 200.

The visualization 200 shows color-coded representations of the threat level of different areas of the building 106, according to a legend 210. Thus, the visualization of the threat assessment can be represented as a “heat map” of various threat levels at different areas of the campus 150. Areas of low threat are represented in a light shade, areas of medium threat are represented in a medium shade, and areas of high threat are represented in a dark shade. In some examples, the color coding can use a first color, e.g., green, for a low threat, a second color, e.g., yellow, for a medium threat, and a third color, e.g., red, for a high threat.

The threat levels shown in the visualization 200 are based on the threat assessment 123. The threat levels can be based on, e.g., a confidence level of the threat, a location of the threat, a speed of movement of the threat, etc. For example, based on analyzing camera image data collected from cameras at the campus 150, the threat assessment engine 122 may determine that there is a high confidence of 90% that the person 110 is carrying a firearm 111. Based on motion sensor data, camera image data, microphone data, and door open/shut data collected from sensors at the campus 150, the threat assessment engine 122 may determine that there is a high confidence of 80% that the person 110 is in the room 220 of the building 106. Thus, based on the high confidence that the person 110 is carrying the firearm 111 and that the person 110 is in the room 220, the threat assessment engine 122 can determine a high threat level in the room 220, and show the room 220 in a dark shade in the visualization 200.

Based on door open/shut data, the threat assessment engine may determine that the doors 208, 212 are shut. The threat assessment engine 122 can determine a medium threat level for rooms adjacent to the room 220 based on the location of the person 110 and based on the doors 208, 212 being shut. Thus, the rooms adjacent to room 220 are shown as a medium shade in the visualization 200. Similarly, rooms that are farther away from the room 220 can be represented by light shading, representing a low threat level.

The visualization 200 can be an interactive visualization. The emergency responder 132 can interact with the visualization 200, e.g., through a user interface provided by the mobile device 136. For example, the emergency responder 132 can zoom in and out to view the visualization 200 in various levels of detail. For example, the emergency responder 132 can zoom in to view a particular room of the building 106, and can zoom out to view the entire building 106, or to view the building 106 and one or more other buildings. In some examples, the visualization 200 is a 3D visualization, and the emergency responder 132 can interact with the visualization 200 by rotating the 3D visualization. By rotating the 3D visualization, the emergency responder 132 can view various access points of the building 106 and paths within the building 106.

The visualization 200 shows exterior access points of the building 106, e.g., exterior door 202, exterior door 204, exterior door 108, and window 206. The visualization 200 also shows interior access points of the building 106, e.g., interior door 208, interior door 212, and interior door 222. In some examples, the visualization 200 can depict an open/shut status and or a locked/unlocked status of access points of the building 106. The open/shut status and the locked/unlocked status of access points can be based on sensor data collected at the building 106, e.g., based on door and window sensors, lock sensors, and/or camera image data. For example, the visualization 200 depicts the doors 202, 204, 208, and 212 being shut. The visualization 200 depicts the door 222 being open. The visualization 200 depicts the doors 204, 108 being unlocked, and the door 202 being locked.

The visualization 200 shows locations of sensors at the building 106, e.g., camera 118, motion sensor 218, camera 214, and microphone 216. The visualization 200 can include depictions of fields of view and ranges of the sensors. For example, the visualization 200 includes a depiction of the field of view 215 of the camera 118.

In some examples, the visualization 200 can be annotated with indications of sensor data collected by the sensors. For example, an annotation 226 at the depiction of the microphone 216 indicates that breaking glass was detected at 2:27 pm. Similarly, the door 108 includes a door lock sensor, and an annotation 224 at the depiction of the door 108 indicates that the door 108 was unlocked at 2:28 pm. An annotation 228 at the depiction of the motion sensor 218 indicates that motion was detected at 2:29 pm. An annotation 230 at the depiction of the camera 214 indicates that the person 110 and the firearm 111 are currently within the field of view of the camera 214.

In some examples, the visualization 200 can be tailored to the emergency responder. For example, an emergency responder that logs into the application using an account associated with security personnel may be provided with a different view that an emergency responder that logs into the application using an account associated with medical personnel. A view provided to security personnel can display, e.g., the estimated location of the person 110, a path through the building 106 that the person 110 has already traversed, a predicted path of the person 110, and suggested safe routes to approach the person 110. A view provided to medical personnel can instead display, e.g., locations of victims and suggested safe routes to approach the victims.

In some examples, the emergency responder 132 can interact with the visualization 200 by selecting devices and sensors depicted in the visualization. Selecting a device or sensor of the visualization 200 can enable the emergency responder 132 to view additional detail and/or to manipulate the device or sensor. For example, the emergency responder 132 may select the depiction of the camera 214 in order to view a current or recent image captured by the camera 214. Upon selecting the depiction of the camera 214, the emergency responder 132 may also be able to manipulate the camera 214, e.g., by tilting or rotating the camera 214 using the interface provided on the mobile device 136. In another example, the emergency responder 132 may select the depiction of the door 202. Upon selecting the depiction of the door 202, the emergency responder 132 can select an option to unlock the door 202 in order to permit the emergency responder 132 to access the building 106 through the door 202.

In some examples, the emergency responder 132 can interact with the visualization 200 in order to perform bulk actions to mitigate the threat. For example, the emergency responder 132 can select an area of the building 106 and select an option to lock down the area. As an example, the emergency responder 132 can select the room 220 on the visualization, and select a “lock down” option displayed through a user interface. Based on the emergency responder 132 selecting the “lock down” option, the monitoring server 130 can send a command to doors, windows, and locks of the room 220 that cause the doors and windows to shut and lock. In the example of a fire threat, the emergency responder 132 can interact with the visualization 200 to select options to initiate fire suppression systems in one or more areas of the building 106.

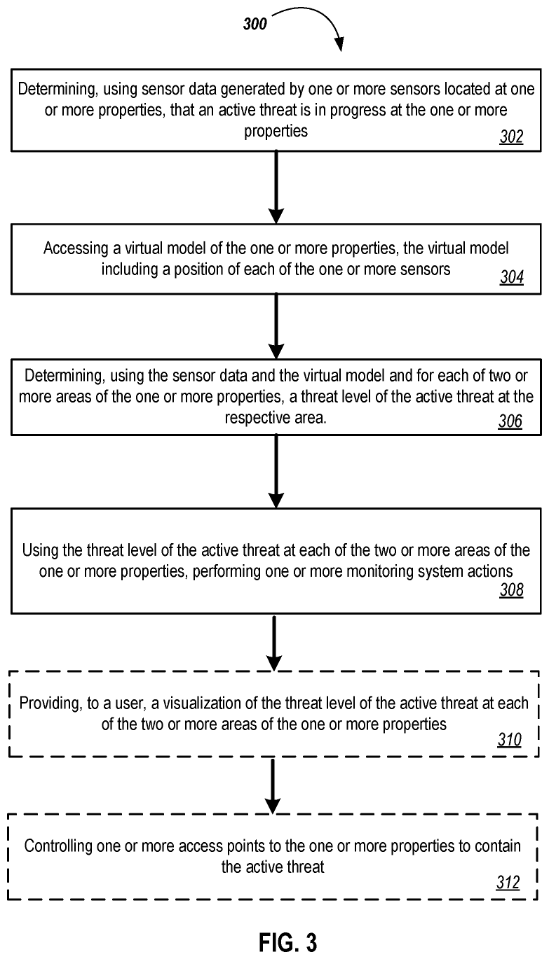

FIG. 3 is a flow diagram illustrating an example process 300 for active threat tracking and response. Process 300 can be performed by one or more computer systems, for example, the monitoring server 130 of monitoring system 100. In some implementations, some or all of the process can be performed by a control unit, e.g., control unit 112, 114, 116 of the monitoring system 100, or by another computer system located at the monitored campus 150.

Briefly, process 300 includes determining, using sensor data generated by one or more sensors located at one or more properties, that an active threat is in progress at the one or more properties (302), accessing a virtual model of the one or more properties, the virtual model including a position of each of the one or more sensors (304), determining, using the sensor data and the virtual model, a threat level of the active threat at each of two or more areas of the one or more properties (306), and based on the threat level of the active threat at each of the two or more areas of the one or more properties, performing one or more monitoring system actions (308). The process 300 can optionally include providing, to a user, a visualization of the threat level of the active threat at each of the two or more areas of the one or more properties (310) and controlling one or more access points to the one or more properties to contain the active threat.

In more detail, the process 300 includes determining, using sensor data generated by one or more sensors located at one or more properties, that an active threat is in progress at the one or more properties (302). For example, the threat assessment engine 122 may receive sensor data 115 and determine that an active shooter is in progress. The sensor data can include, for example, video camera data, audio data, motion sensor data, and temperature data. The sensor data can also include a status of one or more devices at the property. For example, the sensor data can include a door and window position and lock status of the properties. The sensor data can also include the arming status of the monitoring system at each of the properties, e.g., “armed stay,” “armed away,” or “unarmed.” The active threat can be, for example, an active shooter, a fire, a carbon monoxide leak, a flood, a burglary, a physical altercation, etc. In an example, the sensor data can include camera image data showing smoke and flames and smoke sensor data indicating smoke in the building 104. Based on the sensor data, the system can determine that an active threat of a fire is in progress at the building 104.

The process 300 includes accessing a virtual model of the one or more properties, the virtual model including a position of each of the one or more sensors (304). For example, the threat assessment engine 122 can access a virtual model of the building 104. The virtual model can include a position of the camera and of the smoke sensor in the building 104. The virtual model may indicate that the camera and the smoke sensor are located on the fourth floor of the building 104.

The process 300 includes determining, using the sensor data and the virtual model and for each of two or more areas of the one or more properties, a threat level of the active threat at the respective area (306). For example, the threat assessment engine 122 can determine, based on the sensor data 115 and the virtual model a threat level of the fire at multiple different areas of the building 104 and surrounding buildings. For example, the system may determine a high threat level for the fourth floor of the building 104, a medium threat level for the second and third floor of the building 104, and a low threat level for the first floor of the building 104. The system may determine a low threat level for adjacent buildings 102 and 106.

The process 300 includes, using the threat level of the active threat at each of the two or more areas of the one or more properties, performing one or more monitoring system actions (308). For example, based on the high threat level of the fire in the multiple different areas of the building 104, the rules engine 124 may activate a fire alarm at the building 104 and send a notification to an owner of the building 104 and to emergency responders. In some examples, the system may activate additional sensors at the property, such as additional cameras, microphones, and/or motion sensors. The monitoring system may also mitigate the risk of fire by adjusting one or more devices at the property, e.g., by locking doors and windows to contain the fire and by activating a sprinkler system.

The process 300 optionally includes providing, to a user, a visualization of the threat level of the active threat at each of the two or more areas of the one or more properties (310). For example, the monitoring server 130 may generate a visualization that is sent to the mobile device 136 of the emergency responder 132, where the visualization of the threat level of the fire at the building 104 can use a red color to indicate a high threat level of the fourth floor, a yellow color to indicate a medium threat level of the third floor and the second floor, and a green color to indicate a low threat level of the first floor. The visualization can include a depiction of a location of the camera and of the smoke sensor, and an indication of an open/shut status of doors and windows and a locked/unlocked status of doors and windows at the building 104.

The process 300 optionally includes the ability to distinguish threats from non-threats in various ways. Processes include, but are not limited to video or image detection, facial recognition, databases using various methods of identification, electronic tagging, or any combination thereof. For example, the system can identify the threat by video detection of a weapon. In other instances, the system can identify threats or non-threats through facial recognition.

The process 300 optionally includes controlling one or more access points to the one or more properties to contain the active threat (312). For example, the system can control door and window accesses to the building 104 to contain the fire in the building 104, or on the fourth floor of the building 104.

The order of steps in the process 300 described above is illustrative only, and active threat tracking and response can be performed in different orders. For example, the process 300 can perform step 304 and then step 302 or perform these steps substantially concurrently.

In some implementations, the process 300 can include additional steps, fewer steps, or some of the steps can be divided into multiple steps. For example, the process 300 can include steps 302 through 308 without steps 310 or 312. The process 300 can include steps 302 through 310 without step 312. The process 300 can include steps 302 through 308 and step 312 without step 310.

For situations in which the systems discussed here collect personal information about users, or may make use of personal information, the users may be provided with an opportunity to control whether programs or features collect personal information (e.g., information about a user's social network, social actions or activities, profession, a user's preferences, or a user's current location), or to control whether and/or how to receive content from the content server that may be more relevant to the user. In addition, certain data may be anonymized in one or more ways before it is stored or used, so that personally identifiable information is removed. For example, a user's identity may be anonymized so that no personally identifiable information can be determined for the user, or a user's geographic location may be generalized where location information is obtained (such as to a city, ZIP code, or state level), so that a particular location of a user cannot be determined. Thus, the user may have control over how information is collected about him or her and used.

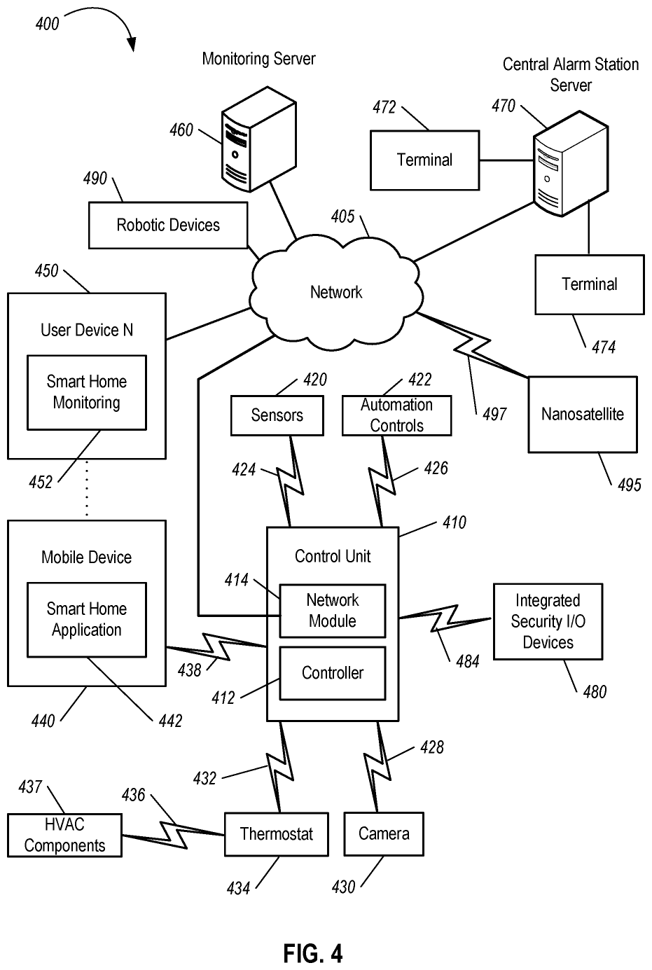

FIG. 4 is a diagram illustrating an example of a home monitoring system 400. The monitoring system 400 includes a network 405, a control unit 410, one or more user devices 440 and 450, a monitoring server 460, and a central alarm station server 470. In some examples, the network 405 facilitates communications between the control unit 410, the one or more user devices 440 and 450, the monitoring server 460, and the central alarm station server 470.

The network 405 is configured to enable exchange of electronic communications between devices connected to the network 405. For example, the network 405 may be configured to enable exchange of electronic communications between the control unit 410, the one or more user devices 440 and 450, the monitoring server 460, and the central alarm station server 470. The network 405 may include, for example, one or more of the Internet, Wide Area Networks (WANs), Local Area Networks (LANs), analog or digital wired and wireless telephone networks (e.g., a public switched telephone network (PSTN), Integrated Services Digital Network (ISDN), a cellular network, and Digital Subscriber Line (DSL)), radio, television, cable, satellite, or any other delivery or tunneling mechanism for carrying data. Network 405 may include multiple networks or subnetworks, each of which may include, for example, a wired or wireless data pathway. The network 405 may include a circuit-switched network, a packet-switched data network, or any other network able to carry electronic communications (e.g., data or voice communications). For example, the network 405 may include networks based on the Internet protocol (IP), asynchronous transfer mode (ATM), the PSTN, packet-switched networks based on IP, X.25, or Frame Relay, or other comparable technologies and may support voice using, for example, VoIP, or other comparable protocols used for voice communications. The network 405 may include one or more networks that include wireless data channels and wireless voice channels. The network 405 may be a wireless network, a broadband network, or a combination of networks including a wireless network and a broadband network.

The control unit 410 includes a controller 412 and a network module 414. The controller 412 is configured to control a control unit monitoring system (e.g., a control unit system) that includes the control unit 410. In some examples, the controller 412 may include a processor or other control circuitry configured to execute instructions of a program that controls operation of a control unit system. In these examples, the controller 412 may be configured to receive input from sensors, flow meters, or other devices included in the control unit system and control operations of devices included in the household (e.g., speakers, lights, doors, etc.). For example, the controller 412 may be configured to control operation of the network module 414 included in the control unit 410.

The network module 414 is a communication device configured to exchange communications over the network 405. The network module 414 may be a wireless communication module configured to exchange wireless communications over the network 405. For example, the network module 414 may be a wireless communication device configured to exchange communications over a wireless data channel and a wireless voice channel. In this example, the network module 414 may transmit alarm data over a wireless data channel and establish a two-way voice communication session over a wireless voice channel. The wireless communication device may include one or more of a LTE module, a GSM module, a radio modem, cellular transmission module, or any type of module configured to exchange communications in one of the following formats: LTE, GSM or GPRS, CDMA, EDGE or EGPRS, EV-DO or EVDO, UMTS, or IP.

The network module 414 also may be a wired communication module configured to exchange communications over the network 405 using a wired connection. For instance, the network module 414 may be a modem, a network interface card, or another type of network interface device. The network module 414 may be an Ethernet network card configured to enable the control unit 410 to communicate over a local area network and/or the Internet. The network module 414 also may be a voice band modem configured to enable the alarm panel to communicate over the telephone lines of Plain Old Telephone Systems (POTS).

The control unit system that includes the control unit 410 includes one or more sensors. For example, the monitoring system may include multiple sensors 420. The sensors 420 may include a lock sensor, a contact sensor, a motion sensor, or any other type of sensor included in a control unit system. The sensors 420 also may include an environmental sensor, such as a temperature sensor, a water sensor, a rain sensor, a wind sensor, a light sensor, a smoke detector, a carbon monoxide detector, an air quality sensor, etc. The sensors 420 further may include a health monitoring sensor, such as a prescription bottle sensor that monitors taking of prescriptions, a blood pressure sensor, a blood sugar sensor, a bed mat configured to sense presence of liquid (e.g., bodily fluids) on the bed mat, etc. In some examples, the health-monitoring sensor can be a wearable sensor that attaches to a user in the home. The health-monitoring sensor can collect various health data, including pulse, heart rate, respiration rate, sugar or glucose level, bodily temperature, or motion data.

The sensors 420 can also include a radio-frequency identification (RFID) sensor that identifies a particular article that includes a pre-assigned RFID tag.

The control unit 410 communicates with the home automation controls 422 and a camera 430 to perform monitoring. The home automation controls 422 are connected to one or more devices that enable automation of actions in the home. For instance, the home automation controls 422 may be connected to one or more lighting systems and may be configured to control operation of the one or more lighting systems. In addition, the home automation controls 422 may be connected to one or more electronic locks at the home and may be configured to control operation of the one or more electronic locks (e.g., control Z-Wave locks using wireless communications in the Z-Wave protocol). Further, the home automation controls 422 may be connected to one or more appliances at the home and may be configured to control operation of the one or more appliances. The home automation controls 422 may include multiple modules that are each specific to the type of device being controlled in an automated manner. The home automation controls 422 may control the one or more devices based on commands received from the control unit 410. For instance, the home automation controls 422 may cause a lighting system to illuminate an area to provide a better image of the area when captured by a camera 430.

The camera 430 may be a video/photographic camera or other type of optical sensing device configured to capture images. For instance, the camera 430 may be configured to capture images of an area within a building or home monitored by the control unit 410. The camera 430 may be configured to capture single, static images of the area and also video images of the area in which multiple images of the area are captured at a relatively high frequency (e.g., thirty images per second). The camera 430 may be controlled based on commands received from the control unit 410.

The camera 430 may be triggered by several different types of techniques. For instance, a Passive Infra-Red (PIR) motion sensor may be built into the camera 430 and used to trigger the camera 430 to capture one or more images when motion is detected. The camera 430 also may include a microwave motion sensor built into the camera and used to trigger the camera 430 to capture one or more images when motion is detected. The camera 430 may have a “normally open” or “normally closed” digital input that can trigger capture of one or more images when external sensors (e.g., the sensors 420, PIR, door/window, etc.) detect motion or other events. In some implementations, the camera 430 receives a command to capture an image when external devices detect motion or another potential alarm event. The camera 430 may receive the command from the controller 412 or directly from one of the sensors 420.

In some examples, the camera 430 triggers integrated or external illuminators (e.g., Infra-Red, Z-wave controlled “white” lights, lights controlled by the home automation controls 422, etc.) to improve image quality when the scene is dark. An integrated or separate light sensor may be used to determine if illumination is desired and may result in increased image quality.

The camera 430 may be programmed with any combination of time/day schedules, system “arming state”, or other variables to determine whether images should be captured or not when triggers occur. The camera 430 may enter a low-power mode when not capturing images. In this case, the camera 430 may wake periodically to check for inbound messages from the controller 412. The camera 430 may be powered by internal, replaceable batteries if located remotely from the control unit 410. The camera 430 may employ a small solar cell to recharge the battery when light is available. Alternatively, the camera 430 may be powered by the controller's 412 power supply if the camera 430 is co-located with the controller 412.

In some implementations, the camera 430 communicates directly with the monitoring server 460 over the Internet. In these implementations, image data captured by the camera 430 does not pass through the control unit 410 and the camera 430 receives commands related to operation from the monitoring server 460.

The system 400 also includes thermostat 434 to perform dynamic environmental control at the home. The thermostat 434 is configured to monitor temperature and/or energy consumption of an HVAC system associated with the thermostat 434, and is further configured to provide control of environmental (e.g., temperature) settings. In some implementations, the thermostat 434 can additionally or alternatively receive data relating to activity at a home and/or environmental data at a home, e.g., at various locations indoors and outdoors at the home. The thermostat 434 can directly measure energy consumption of the HVAC system associated with the thermostat, or can estimate energy consumption of the HVAC system associated with the thermostat 434, for example, based on detected usage of one or more components of the HVAC system associated with the thermostat 434. The thermostat 434 can communicate temperature and/or energy monitoring information to or from the control unit 410 and can control the environmental (e.g., temperature) settings based on commands received from the control unit 410.

In some implementations, the thermostat 434 is a dynamically programmable thermostat and can be integrated with the control unit 410. For example, the dynamically programmable thermostat 434 can include the control unit 410, e.g., as an internal component to the dynamically programmable thermostat 434. In addition, the control unit 410 can be a gateway device that communicates with the dynamically programmable thermostat 434. In some implementations, the thermostat 434 is controlled via one or more home automation controls 422.

A module 437 is connected to one or more components of an HVAC system associated with a home, and is configured to control operation of the one or more components of the HVAC system. In some implementations, the module 437 is also configured to monitor energy consumption of the HVAC system components, for example, by directly measuring the energy consumption of the HVAC system components or by estimating the energy usage of the one or more HVAC system components based on detecting usage of components of the HVAC system. The module 437 can communicate energy monitoring information and the state of the HVAC system components to the thermostat 434 and can control the one or more components of the HVAC system based on commands received from the thermostat 434.

In some examples, the system 400 further includes one or more robotic devices 490. The robotic devices 490 may be any type of robots that are capable of moving and taking actions that assist in home monitoring. For example, the robotic devices 490 may include drones that are capable of moving throughout a home based on automated control technology and/or user input control provided by a user. In this example, the drones may be able to fly, roll, walk, or otherwise move about the home. The drones may include helicopter type devices (e.g., quad copters), rolling helicopter type devices (e.g., roller copter devices that can fly and roll along the ground, walls, or ceiling) and land vehicle type devices (e.g., automated cars that drive around a home). In some cases, the robotic devices 490 may be devices that are intended for other purposes and merely associated with the system 400 for use in appropriate circumstances. For instance, a robotic vacuum cleaner device may be associated with the monitoring system 400 as one of the robotic devices 490 and may be controlled to take action responsive to monitoring system events.

In some examples, the robotic devices 490 automatically navigate within a home. In these examples, the robotic devices 490 include sensors and control processors that guide movement of the robotic devices 490 within the home. For instance, the robotic devices 490 may navigate within the home using one or more cameras, one or more proximity sensors, one or more gyroscopes, one or more accelerometers, one or more magnetometers, a global positioning system (GPS) unit, an altimeter, one or more sonar or laser sensors, and/or any other types of sensors that aid in navigation about a space. The robotic devices 490 may include control processors that process output from the various sensors and control the robotic devices 490 to move along a path that reaches the desired destination and avoids obstacles. In this regard, the control processors detect walls or other obstacles in the home and guide movement of the robotic devices 490 in a manner that avoids the walls and other obstacles.

In addition, the robotic devices 490 may store data that describes attributes of the home. For instance, the robotic devices 490 may store a floorplan and/or a three-dimensional model of the home that enables the robotic devices 490 to navigate the home. During initial configuration, the robotic devices 490 may receive the data describing attributes of the home, determine a frame of reference to the data (e.g., a home or reference location in the home), and navigate the home based on the frame of reference and the data describing attributes of the home. Further, initial configuration of the robotic devices 490 also may include learning of one or more navigation patterns in which a user provides input to control the robotic devices 490 to perform a specific navigation action (e.g., fly to an upstairs bedroom and spin around while capturing video and then return to a home charging base). In this regard, the robotic devices 490 may learn and store the navigation patterns such that the robotic devices 490 may automatically repeat the specific navigation actions upon a later request.

In some examples, the robotic devices 490 may include data capture and recording devices. In these examples, the robotic devices 490 may include one or more cameras, one or more motion sensors, one or more microphones, one or more biometric data collection tools, one or more temperature sensors, one or more humidity sensors, one or more air flow sensors, and/or any other types of sensors that may be useful in capturing monitoring data related to the home and users in the home. The one or more biometric data collection tools may be configured to collect biometric samples of a person in the home with or without contact of the person. For instance, the biometric data collection tools may include a fingerprint scanner, a hair sample collection tool, a skin cell collection tool, and/or any other tool that allows the robotic devices 490 to take and store a biometric sample that can be used to identify the person (e.g., a biometric sample with DNA that can be used for DNA testing).

In some implementations, the robotic devices 490 may include output devices. In these implementations, the robotic devices 490 may include one or more displays, one or more speakers, and/or any type of output devices that allow the robotic devices 490 to communicate information to a nearby user.

The robotic devices 490 also may include a communication module that enables the robotic devices 490 to communicate with the control unit 410, each other, and/or other devices. The communication module may be a wireless communication module that allows the robotic devices 490 to communicate wirelessly. For instance, the communication module may be a Wi-Fi module that enables the robotic devices 490 to communicate over a local wireless network at the home. The communication module further may be a 900 MHz wireless communication module that enables the robotic devices 490 to communicate directly with the control unit 410. Other types of short-range wireless communication protocols, such as Bluetooth, Bluetooth LE, Z-wave, Zigbee, etc., may be used to allow the robotic devices 490 to communicate with other devices in the home. In some implementations, the robotic devices 490 may communicate with each other or with other devices of the system 400 through the network 405.

The robotic devices 490 further may include processor and storage capabilities. The robotic devices 490 may include any suitable processing devices that enable the robotic devices 490 to operate applications and perform the actions described throughout this disclosure. In addition, the robotic devices 490 may include solid-state electronic storage that enables the robotic devices 490 to store applications, configuration data, collected sensor data, and/or any other type of information available to the robotic devices 490.

The robotic devices 490 are associated with one or more charging stations. The charging stations may be located at predefined home base or reference locations in the home. The robotic devices 490 may be configured to navigate to the charging stations after completion of tasks needed to be performed for the monitoring system 400. For instance, after completion of a monitoring operation or upon instruction by the control unit 410, the robotic devices 490 may be configured to automatically fly to and land on one of the charging stations. In this regard, the robotic devices 490 may automatically maintain a fully charged battery in a state in which the robotic devices 490 are ready for use by the monitoring system 400.

The charging stations may be contact based charging stations and/or wireless charging stations. For contact based charging stations, the robotic devices 490 may have readily accessible points of contact that the robotic devices 490 are capable of positioning and mating with a corresponding contact on the charging station. For instance, a helicopter type robotic device may have an electronic contact on a portion of its landing gear that rests on and mates with an electronic pad of a charging station when the helicopter type robotic device lands on the charging station. The electronic contact on the robotic device may include a cover that opens to expose the electronic contact when the robotic device is charging and closes to cover and insulate the electronic contact when the robotic device is in operation.

For wireless charging stations, the robotic devices 490 may charge through a wireless exchange of power. In these cases, the robotic devices 490 need only locate themselves closely enough to the wireless charging stations for the wireless exchange of power to occur. In this regard, the positioning needed to land at a predefined home base or reference location in the home may be less precise than with a contact based charging station. Based on the robotic devices 490 landing at a wireless charging station, the wireless charging station outputs a wireless signal that the robotic devices 490 receive and convert to a power signal that charges a battery maintained on the robotic devices 490.

In some implementations, each of the robotic devices 490 has a corresponding and assigned charging station such that the number of robotic devices 490 equals the number of charging stations. In these implementations, the robotic devices 490 always navigate to the specific charging station assigned to that robotic device. For instance, a first robotic device may always use a first charging station and a second robotic device may always use a second charging station.

In some examples, the robotic devices 490 may share charging stations. For instance, the robotic devices 490 may use one or more community charging stations that are capable of charging multiple robotic devices 490. The community charging station may be configured to charge multiple robotic devices 490 in parallel. The community charging station may be configured to charge multiple robotic devices 490 in serial such that the multiple robotic devices 490 take turns charging and, when fully charged, return to a predefined home base or reference location in the home that is not associated with a charger. The number of community charging stations may be less than the number of robotic devices 490.

In addition, the charging stations may not be assigned to specific robotic devices 490 and may be capable of charging any of the robotic devices 490. In this regard, the robotic devices 490 may use any suitable, unoccupied charging station when not in use. For instance, when one of the robotic devices 490 has completed an operation or is in need of battery charge, the control unit 410 references a stored table of the occupancy status of each charging station and instructs the robotic device to navigate to the nearest charging station that is unoccupied.

The system 400 further includes one or more integrated security devices 480. The one or more integrated security devices may include any type of device used to provide alerts based on received sensor data. For instance, the one or more control units 410 may provide one or more alerts to the one or more integrated security input/output devices 480. Additionally, the one or more control units 410 may receive one or more sensor data from the sensors 420 and determine whether to provide an alert to the one or more integrated security input/output devices 480.

The sensors 420, the home automation controls 422, the camera 430, the thermostat 434, and the integrated security devices 480 may communicate with the controller 412 over communication links 424, 426, 428, 432, 438, and 484. The communication links 424, 426, 428, 432, 438, and 484 may be a wired or wireless data pathway configured to transmit signals from the sensors 420, the home automation controls 422, the camera 430, the thermostat 434, and the integrated security devices 480 to the controller 412. The sensors 420, the home automation controls 422, the camera 430, the thermostat 434, and the integrated security devices 480 may continuously transmit sensed values to the controller 412, periodically transmit sensed values to the controller 412, or transmit sensed values to the controller 412 in response to a change in a sensed value.

The communication links 424, 426, 428, 432, 438, and 484 may include a local network. The sensors 420, the home automation controls 422, the camera 430, the thermostat 434, and the integrated security devices 480, and the controller 412 may exchange data and commands over the local network. The local network may include 802.11 “Wi-Fi” wireless Ethernet (e.g., using low-power Wi-Fi chipsets), Z-Wave, Zigbee, Bluetooth, “Homeplug” or other “Powerline” networks that operate over AC wiring, and a Category 5 (CATS) or Category 6 (CAT6) wired Ethernet network. The local network may be a mesh network constructed based on the devices connected to the mesh network.

The monitoring server 460 is an electronic device configured to provide monitoring services by exchanging electronic communications with the control unit 410, the one or more user devices 440 and 450, and the central alarm station server 470 over the network 405. For example, the monitoring server 460 may be configured to monitor events generated by the control unit 410. In this example, the monitoring server 460 may exchange electronic communications with the network module 414 included in the control unit 410 to receive information regarding events detected by the control unit 410. The monitoring server 460 also may receive information regarding events from the one or more user devices 440 and 450.

In some examples, the monitoring server 460 may route alert data received from the network module 414 or the one or more user devices 440 and 450 to the central alarm station server 470. For example, the monitoring server 460 may transmit the alert data to the central alarm station server 470 over the network 405.

The monitoring server 460 may store sensor and image data received from the monitoring system and perform analysis of sensor and image data received from the monitoring system. Based on the analysis, the monitoring server 460 may communicate with and control aspects of the control unit 410 or the one or more user devices 440 and 450.

The monitoring server 460 may provide various monitoring services to the system 400. For example, the monitoring server 460 may analyze the sensor, image, and other data to determine an activity pattern of a resident of the home monitored by the system 400. In some implementations, the monitoring server 460 may analyze the data for alarm conditions or may determine and perform actions at the home by issuing commands to one or more of the controls 422, possibly through the control unit 410.

The monitoring server 460 can be configured to provide information (e.g., activity patterns) related to one or more residents of the home monitored by the system 400. For example, one or more of the sensors 420, the home automation controls 422, the camera 430, the thermostat 434, and the integrated security devices 480 can collect data related to a resident including location information (e.g., if the resident is home or is not home) and provide location information to the thermostat 434.

The central alarm station server 470 is an electronic device configured to provide alarm monitoring service by exchanging communications with the control unit 410, the one or more user devices 440 and 450, and the monitoring server 460 over the network 405. For example, the central alarm station server 470 may be configured to monitor alerting events generated by the control unit 410. In this example, the central alarm station server 470 may exchange communications with the network module 414 included in the control unit 410 to receive information regarding alerting events detected by the control unit 410. The central alarm station server 470 also may receive information regarding alerting events from the one or more user devices 440 and 450 and/or the monitoring server 460.

The central alarm station server 470 is connected to multiple terminals 472 and 474. The terminals 472 and 474 may be used by operators to process alerting events. For example, the central alarm station server 470 may route alerting data to the terminals 472 and 474 to enable an operator to process the alerting data. The terminals 472 and 474 may include general-purpose computers (e.g., desktop personal computers, workstations, or laptop computers) that are configured to receive alerting data from a server in the central alarm station server 470 and render a display of information based on the alerting data. For instance, the controller 412 may control the network module 414 to transmit, to the central alarm station server 470, alerting data indicating that a sensor 420 detected motion from a motion sensor via the sensors 420. The central alarm station server 470 may receive the alerting data and route the alerting data to the terminal 472 for processing by an operator associated with the terminal 472. The terminal 472 may render a display to the operator that includes information associated with the alerting event (e.g., the lock sensor data, the motion sensor data, the contact sensor data, etc.) and the operator may handle the alerting event based on the displayed information.

In some implementations, the terminals 472 and 474 may be mobile devices or devices designed for a specific function. Although FIG. 4 illustrates two terminals for brevity, actual implementations may include more (and, perhaps, many more) terminals.

The one or more authorized user devices 440 and 450 are devices that host and display user interfaces. For instance, the user device 440 is a mobile device that hosts or runs one or more native applications (e.g., the home monitoring application 442). The user device 440 may be a cellular phone or a non-cellular locally networked device with a display. The user device 440 may include a cell phone, a smart phone, a tablet PC, a personal digital assistant (“PDA”), or any other portable device configured to communicate over a network and display information. For example, implementations may also include Blackberry-type devices (e.g., as provided by Research in Motion), electronic organizers, iPhone-type devices (e.g., as provided by Apple), iPod devices (e.g., as provided by Apple) or other portable music players, other communication devices, and handheld or portable electronic devices for gaming, communications, and/or data organization. The user device 440 may perform functions unrelated to the monitoring system, such as placing personal telephone calls, playing music, playing video, displaying pictures, browsing the Internet, maintaining an electronic calendar, etc.

The user device 440 includes a home monitoring application 452. The home monitoring application 442 refers to a software/firmware program running on the corresponding mobile device that enables the user interface and features described throughout. The user device 440 may load or install the home monitoring application 442 based on data received over a network or data received from local media. The home monitoring application 442 runs on mobile devices platforms, such as iPhone, iPod touch, Blackberry, Google Android, Windows Mobile, etc. The home monitoring application 442 enables the user device 440 to receive and process image and sensor data from the monitoring system.

The user device 440 may be a general-purpose computer (e.g., a desktop personal computer, a workstation, or a laptop computer) that is configured to communicate with the monitoring server 460 and/or the control unit 410 over the network 405. The user device 440 may be configured to display a smart home user interface 452 that is generated by the user device 440 or generated by the monitoring server 460. For example, the user device 440 may be configured to display a user interface (e.g., a web page) provided by the monitoring server 460 that enables a user to perceive images captured by the camera 430 and/or reports related to the monitoring system. Although FIG. 4 illustrates two user devices for brevity, actual implementations may include more (and, perhaps, many more) or fewer user devices.

In some implementations, the one or more user devices 440 and 450 communicate with and receive monitoring system data from the control unit 410 using the communication link 438. For instance, the one or more user devices 440 and 450 may communicate with the control unit 410 using various local wireless protocols such as Wi-Fi, Bluetooth, Z-wave, Zigbee, HomePlug (ethernet over power line), or wired protocols such as Ethernet and USB, to connect the one or more user devices 440 and 450 to local security and automation equipment. The one or more user devices 440 and 450 may connect locally to the monitoring system and its sensors and other devices. The local connection may improve the speed of status and control communications because communicating through the network 405 with a remote server (e.g., the monitoring server 460) may be significantly slower.

Although the one or more user devices 440 and 450 are shown as communicating with the control unit 410, the one or more user devices 440 and 450 may communicate directly with the sensors and other devices controlled by the control unit 410. In some implementations, the one or more user devices 440 and 450 replace the control unit 410 and perform the functions of the control unit 410 for local monitoring and long range/offsite communication.

In other implementations, the one or more user devices 440 and 450 receive monitoring system data captured by the control unit 410 through the network 405. The one or more user devices 440, 450 may receive the data from the control unit 410 through the network 405 or the monitoring server 460 may relay data received from the control unit 410 to the one or more user devices 440 and 450 through the network 405. In this regard, the monitoring server 460 may facilitate communication between the one or more user devices 440 and 450 and the monitoring system.

In some implementations, the one or more user devices 440 and 450 may be configured to switch whether the one or more user devices 440 and 450 communicate with the control unit 410 directly (e.g., through link 438) or through the monitoring server 460 (e.g., through network 405) based on a location of the one or more user devices 440 and 450. For instance, when the one or more user devices 440 and 450 are located close to the control unit 410 and in range to communicate directly with the control unit 410, the one or more user devices 440 and 450 use direct communication. When the one or more user devices 440 and 450 are located far from the control unit 410 and not in range to communicate directly with the control unit 410, the one or more user devices 440 and 450 use communication through the monitoring server 460.

Although the one or more user devices 440 and 450 are shown as being connected to the network 405, in some implementations, the one or more user devices 440 and 450 are not connected to the network 405. In these implementations, the one or more user devices 440 and 450 communicate directly with one or more of the monitoring system components and no network (e.g., Internet) connection or reliance on remote servers is needed.

In some implementations, the one or more user devices 440 and 450 are used in conjunction with only local sensors and/or local devices in a house. In these implementations, the system 400 includes the one or more user devices 440 and 450, the sensors 420, the home automation controls 422, the camera 430, and the robotic devices 490. The one or more user devices 440 and 450 receive data directly from the sensors 420, the home automation controls 422, the camera 430, and the robotic devices 490, and sends data directly to the sensors 420, the home automation controls 422, the camera 430, and the robotic devices 490. The one or more user devices 440, 450 provide the appropriate interfaces/processing to provide visual surveillance and reporting.

In other implementations, the system 400 further includes network 405 and the sensors 420, the home automation controls 422, the camera 430, the thermostat 434, and the robotic devices 490, and are configured to communicate sensor and image data to the one or more user devices 440 and 450 over network 405 (e.g., the Internet, cellular network, etc.). In yet another implementation, the sensors 420, the home automation controls 422, the camera 430, the thermostat 434, and the robotic devices 490 (or a component, such as a bridge/router) are intelligent enough to change the communication pathway from a direct local pathway when the one or more user devices 440 and 450 are in close physical proximity to the sensors 420, the home automation controls 422, the camera 430, the thermostat 434, and the robotic devices 490 to a pathway over network 405 when the one or more user devices 440 and 450 are farther from the sensors 420, the home automation controls 422, the camera 430, the thermostat 434, and the robotic devices 490.

In some examples, the system leverages GPS information from the one or more user devices 440 and 450 to determine whether the one or more user devices 440 and 450 are close enough to the sensors 420, the home automation controls 422, the camera 430, the thermostat 434, and the robotic devices 490 to use the direct local pathway or whether the one or more user devices 440 and 450 are far enough from the sensors 420, the home automation controls 422, the camera 430, the thermostat 434, and the robotic devices 490 that the pathway over network 405 is required.

In other examples, the system leverages status communications (e.g., pinging) between the one or more user devices 440 and 450 and the sensors 420, the home automation controls 422, the camera 430, the thermostat 434, and the robotic devices 490 to determine whether communication using the direct local pathway is possible. If communication using the direct local pathway is possible, the one or more user devices 440 and 450 communicate with the sensors 420, the home automation controls 422, the camera 430, the thermostat 434, and the robotic devices 490 using the direct local pathway. If communication using the direct local pathway is not possible, the one or more user devices 440 and 450 communicate with the sensors 420, the home automation controls 422, the camera 430, the thermostat 434, and the robotic devices 490 using the pathway over network 405.

In some implementations, the system 400 provides end users with access to images captured by the camera 430 to aid in decision making. The system 400 may transmit the images captured by the camera 430 over a wireless WAN network to the user devices 440 and 450. Because transmission over a wireless WAN network may be relatively expensive, the system 400 can use several techniques to reduce costs while providing access to significant levels of useful visual information (e.g., compressing data, down-sampling data, sending data only over inexpensive LAN connections, or other techniques).

In some implementations, a state of the monitoring system and other events sensed by the monitoring system may be used to enable/disable video/image recording devices (e.g., the camera 430). In these implementations, the camera 430 may be set to capture images on a periodic basis when the alarm system is armed in an “away” state, but set not to capture images when the alarm system is armed in a “home” state or disarmed. In addition, the camera 430 may be triggered to begin capturing images when the alarm system detects an event, such as an alarm event, a door-opening event for a door that leads to an area within a field of view of the camera 430, or motion in the area within the field of view of the camera 430. In other implementations, the camera 430 may capture images continuously, but the captured images may be stored or transmitted over a network when needed.

The described systems, methods, and techniques may be implemented in digital electronic circuitry, computer hardware, firmware, software, or in combinations of these elements. Apparatus implementing these techniques may include appropriate input and output devices, a computer processor, and a computer program product tangibly embodied in a machine-readable storage device for execution by a programmable processor. A process implementing these techniques may be performed by a programmable processor executing a program of instructions to perform desired functions by operating on input data and generating appropriate output. The techniques may be implemented in one or more computer programs that are executable on a programmable system including at least one programmable processor coupled to receive data and instructions from, and to transmit data and instructions to, a data storage system, at least one input device, and at least one output device.

Each computer program may be implemented in a high-level procedural or object-oriented programming language, or in assembly or machine language if desired; and in any case, the language may be a compiled or interpreted language. Suitable processors include, by way of example, both general and special purpose microprocessors. Generally, a processor will receive instructions and data from a read-only memory and/or a random access memory. Storage devices suitable for tangibly embodying computer program instructions and data include all forms of non-volatile memory, including by way of example semiconductor memory devices, such as Erasable Programmable Read-Only Memory (EPROM), Electrically Erasable Programmable Read-Only Memory (EEPROM), and flash memory devices; magnetic disks such as internal hard disks and removable disks; magneto-optical disks; and Compact Disc Read-Only Memory (CD-ROM). Any of the foregoing may be supplemented by, or incorporated in, specially designed ASICs (application-specific integrated circuits).

It will be understood that various modifications may be made. For example, other useful implementations could be achieved if steps of the disclosed techniques were performed in a different order and/or if components in the disclosed systems were combined in a different manner and/or replaced or supplemented by other components. Accordingly, other implementations are within the scope of the disclosure.

1. A computer-implemented method comprising:
determining, using sensor data generated by one or more sensors located at one or more properties, that an active threat is in progress at the one or more properties;
accessing a virtual model i) of the one or more properties ii) that includes a position of each of the one or more sensors;
determining, using the sensor data and the virtual model and for each of two or more areas of the one or more properties, a threat level of the active threat at the respective area; and
performing, using the threat level of the active threat at each of the two or more areas of the one or more properties, one or more monitoring system actions.

2. The method of claim 1, wherein performing the one or more monitoring system actions comprises sending, to a device at one of the one or more properties, instructions to cause the device to perform a monitoring system action.

3. The method of claim 1, wherein performing the one or more monitoring system actions comprises sending, to a device at one of the one or more properties, instructions to cause the device to control access to an access point at one of the one or more properties to contain the active threat.

4. The method of claim 3, wherein sending the instructions comprises sending, to the device, the instructions to cause the device to open the access point.

5. The method of claim 3, wherein sending the instructions comprises sending, to the device, the instructions to cause the device to close the access point.

6. The method of claim 3, wherein sending the instructions comprises sending, to the device, the instructions to cause the device to unlock the access point.

7. The method of claim 3, wherein sending the instructions comprises sending, to the device, the instructions to cause the device to lock the access point.

8. The method of claim 3, comprising:
determining, using the sensor data by one or more sensors located at one or more properties, an estimated track of a threat through a property, wherein sending the instructions to cause the device to perform the one or more monitoring system actions uses the estimated track of the active threat through the property.

9. The method of claim 8, comprising:
determining an approximate location of a bystander user device, wherein sending the instructions to cause the device to perform the one or more monitoring system actions uses the estimated track of a threat through the property and the approximate location of the bystander user device.

10. The method of claim 1, wherein:
determining the threat level comprises:
determining a first threat level for a first area in the two or more areas; and
determining a second different threat level for a second different area in the two or more areas;
performing the one or more monitoring system actions comprises:
performing, using the first threat level, a first action for the first area; and
performing, using the second different threat level, a second different action for the second different area.

11. The method of claim 1, wherein performing the one or more monitoring system actions comprises sending, to a device, instructions to cause the device to present the threat level of the active threat at each of the two or more areas of the one or more properties.

12. The method of claim 1, wherein performing the one or more monitoring system actions comprises sending, to a device, instructions to cause the device to present a visualization of the threat level of the active threat at each of the two or more areas of the one or more properties.

13. The method of claim 1, wherein:
determining a threat level comprises determining a threat type; and
performing the one or more monitoring system actions comprises performing actions using the threat type.

14. A system comprising one or more computers and one or more storage devices on which are stored instructions that are operable, when executed by the one or more computers, to cause the one or more computers to perform operations comprising:
determining, using sensor data generated by one or more sensors located at one or more properties, that an active threat is in progress at the one or more properties;
accessing a virtual model i) of the one or more properties ii) that includes a position of each of the one or more sensors;
determining, using the sensor data and the virtual model and for each of two or more areas of the one or more properties, a threat level of the active threat at the respective area; and
performing, using the threat level of the active threat at each of the two or more areas of the one or more properties, one or more monitoring system actions.

15. The system of claim 14, wherein:
determining the threat level comprises:
determining a first threat level for a first area in the two or more areas; and
determining a second different threat level for a second different area in the two or more areas;
performing the one or more monitoring system actions comprises:
performing, using the first threat level, a first action for the first area; and
performing, using the second different threat level, a second different action for the second different area.

16. The system of claim 14, wherein performing the one or more monitoring system actions comprises sending, to a device, instructions to cause the device to present the threat level of the active threat at each of the two or more areas of the one or more properties.

17. The system of claim 14, wherein performing the one or more monitoring system actions comprises sending, to a device, instructions to cause the device to present a visualization of the threat level of the active threat at each of the two or more areas of the one or more properties.

18. The system of claim 14, wherein:
determining a threat level comprises determining a threat type; and
performing the one or more monitoring system actions comprises performing actions using the threat type.

19. A non-transitory computer storage medium encoded with instructions that, when executed by one or more computers, cause the one or more computers to perform operations comprising:
determining, using sensor data generated by one or more sensors located at one or more properties, that an active threat is in progress at the one or more properties;
accessing a virtual model i) of the one or more properties ii) that includes a position of each of the one or more sensors;
determining, using the sensor data and the virtual model and for each of two or more areas of the one or more properties, a threat level of the active threat at the respective area; and
performing, using the threat level of the active threat at each of the two or more areas of the one or more properties, one or more monitoring system actions.

20. The computer storage medium of claim 19, wherein:
determining the threat level comprises:
determining a first threat level for a first area in the two or more areas; and
determining a second different threat level for a second different area in the two or more areas;
performing the one or more monitoring system actions comprises:
performing, using the first threat level, a first action for the first area; and
performing, using the second different threat level, a second different action for the second different area.
